(19) United States
(12) Patent Application Publication
(10) Pub. No.: US 2006/0271545 A1
(43) Pub. Date: Nov. 30, 2006

(54) Real-time knowledge information search system using wired/wireless networks, method for searching knowledge information in real time, and method for registering/managing knowledge information in real time

(76) Inventors: Joon-Soo Youn, GYEONGGI-DO (KR); Hyun-Duck Kim, Gyeonggi-do (KR)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/521,057

(22) PCT Filed: Mar. 17, 2004
(86) PCT No.: PCT/KR04/00579

§ 371 Date: Jan. 12, 2005

(30) Foreign Application Priority Data
Dec. 16, 2003 (KR) 10-2003-0091815

(51) Int. Cl. G06F 17/30

(52) U.S. Cl. 707/10

(57) ABSTRACT

A real-time knowledge information search system using wired/wireless networks and a method for registering/managing knowledge information using the same. One or more user terminals are connected to the communication networks, for the on-line generation of inquiry information and the receipt of corresponding materials for the inquiry, and one or more expert terminals connected to the communication networks, for providing reply information of pertinent knowledge. A service server transmits the inquiry information of the user to the expert terminals that are being currently connected, transmits the expert's reply information to the user terminal on-line and classifies data for the reply information, in response to the user's information request. A professional knowledge information database is connected to the service server, for classifying/storing the reply information provided from the expert terminals therein. The reply information is used as professional knowledge information corresponding to a user's professional knowledge request.

### TECHNICAL FIELD

The present invention relates to search, registration and management of knowledge information on-line. More particularly, the present invention relates to a real-time knowledge information search system using wired/wireless networks, a method for searching knowledge information in real time and a method for registering/managing knowledge information in real time, in which requests and replies of knowledge information classified by the region/language can be performed in real time through a messenger, thereby improving reliability of a knowledge search through databased reply.

### BACKGROUND ART

Generally, there are a lot of visitors in Internet portal sites. Large amounts of information generated in the sites are exchanged among the visitors. Such exchange of the information includes exchange of lots of information though a search engine as well as transmission of brief information through a predetermined messenger. The search engine collects related materials based on keyword inputted by a user and then provides the user with the results. This kind of the search method has been used in a number of portal sites.

If the user wants to receive predetermined materials after accessing a specific portal site, the user can be provided with a large amount of information including keyword by inputting corresponding keyword. Therefore, as whether the materials are correct or not is determined according to keyword selection of the user, the user can search desired information using a number of keywords. This is because only the keyword inputted by the user becomes a basis for searching materials. Further, the search engine itself searches only information such as documents, materials, etc. containing keywords and lists even unnecessary information. This degrades the reliability of the search.

### DISCLOSURE OF INVENTION

Accordingly, the present invention has been made in view of the above problems, and it is an object of the present invention to provide a real-time knowledge information search system using wired/wireless networks, a method for searching knowledge information in real time and a method for registering/managing knowledge information in real time, wherein fields of knowledge to be searched and knowledge information from knowledge experts are provided in real time, improving reliability for the knowledge search on-line.

To achieve the above objects, according to a first aspect of the present invention, there is provided a real-time knowledge information search system using wired/wireless communication networks for providing an on-line portal service to a user terminal through the wired/wireless communication networks, including one or more user terminals connected to the wired/wireless communication networks, for generating inquiry information using an on-line communication means and receiving corresponding materials for the inquiry; one or more expert terminals connected to the wired/wireless communication networks, for providing reply information of pertinent knowledge classified by corresponding fields according to a user's information request; a service server for transmitting the inquiry information of the user to the expert terminals that are being currently connected, transmitting the expert's reply information to the user terminal through the on-line communication means, and classifying data for the reply information, in response to the user's information request; and a professional knowledge information database connected to the service server, for classifying/storing the reply information provided from the expert terminals therein, so that the reply information is used as professional knowledge information corresponding to a user's professional knowledge request.

It is preferred that the user terminals are any one of a personal computer, a mobile phone and a PDA, which can connect to the Internet.

Further, the one or more expert terminals are expert's terminals that are being currently connected, which are classified by the field, language and region. The on-line communication means is a messenger.

Furthermore, the user terminal performs an on-line connection of the on-line communication means via predetermined authentication procedure, and the service server has a Single Sign On (SSO) security application solution therein, which permits access of the user terminals based on a user's log-in information that is initially inputted.

Also, the user terminals provide the degree of satisfaction for the reply information in numerical information, the professional knowledge information database matches the reply information and the numerical information and then stores the matched information therein, and the service server provides corresponding reply information and its corresponding numerical information when the user requests professional knowledge.

Meanwhile, according to a second aspect of the present invention, there is provided a method for searching knowledge information for an on-line portal service in real-time using wired/wireless communication networks, including the steps of a) performing an authentication procedure for accessing an on-line communication means to a user terminal; b) generating inquiry information for a knowledge search through the on-line communication means; c) analyzing the inquiry information, and extracting previously stored basic information from a database depending on the analysis result; d) providing list information on the basic information through a web page of the portal service; e) confirming reply information provided from the list information through the user terminal, and if detailed information on the reply information is not requested, finishing a corresponding process and if detailed information on the reply information is requested, searching a plurality of experts who are previously registered based on the analysis result for the inquiry information; f) extracting an expert who is being currently connected among the plurality of the experts, and transmitting the inquiry information to an expert terminal of the selected expert through the on-line communication means; g) requesting an on-line access for transmitting the reply information corresponding to the inquiry information, which is provided from the expert terminal, to the user terminal; h) if the user terminal does not accept the on-line access request, finishing a corresponding process, and if the user terminal accepts the on-line access request, allowing the user terminal and the expert terminal to be connected one-to-one with each other through a real-time on-line information transmit means; i) storing reply information provided to the user terminal in the database during the one-to-one connection between the user terminal and the expert terminal; and j) in response to the reply information, finishing a corresponding process or returning to step f) by providing added/modified information for the inquiry information.

It is preferable that the on-line communication means is a messenger.

Further, the access to the database through the on-line communication means is an access method based on personal information provided in the authentication procedure and a SSO security application solution.

Meanwhile, according to a third aspect of the present invention, there is provided a method for registering/managing knowledge information for an on-line portal service, including the steps of a) performing an authentication procedure for accessing an on-line communication means to a user terminal; b) generating inquiry information through the on-line communication means; c) searching a plurality of experts who are previously registered based on an analysis result into the inquiry information; d) extracting an expert who is being currently connected to the Internet among the plurality of the experts, and sending the inquiry information to an expert terminal of the extracted expert through the on-line communication means; e) requesting an on-line access for transmitting reply information corresponding to the inquiry information that is provided from the expert terminal, to the user terminal; f) if there is no acceptance for the on-line access request from the user terminal, finishing a corresponding process, and if there is acceptance for the on-line access request from the user terminal, allowing the user terminal and the expert terminal to be connected one-to-one with each other through a real-time on-line information transmit means; g) storing the inquiry information and the reply information, being the results of the communication exchange among the user terminal and the expert terminal, in a database; and h) in response to the reply information, finishing a corresponding process, or returning to step e) by providing added/modified information for the inquiry information through the user terminal.

Preferably, the on-line communication means is a messenger, and the real-time on-line information transmit means is a chatting window, which is any one of chatting, a web phone, image chatting and a web board.

Furthermore, the user terminal generates evaluation information on the reply information, and the database matches the inquiry information and the reply information, and the evaluation information, and then stores the matched information therein.

### BRIEF DESCRIPTION OF DRAWINGS

Further objects and advantages of the invention can be more fully understood from the following detailed description taken in conjunction with the accompanying drawings in which:

FIG. 1 is a diagram illustrating the construction of a knowledge information search system according to the present invention;

FIG. 2 is a diagram illustrating the construction of a service server shown in FIG. 1;

FIG. 3 and FIG. 4 are flowcharts shown to explain main operations in a network according to the present invention; and

FIG. 5 shows a messenger having a knowledge information search function according to an embodiment of the present invention.

### BEST MODE FOR CARRYING OUT THE INVENTION

The present invention will now be described in detail in connection with preferred embodiments with reference to the accompanying drawings.

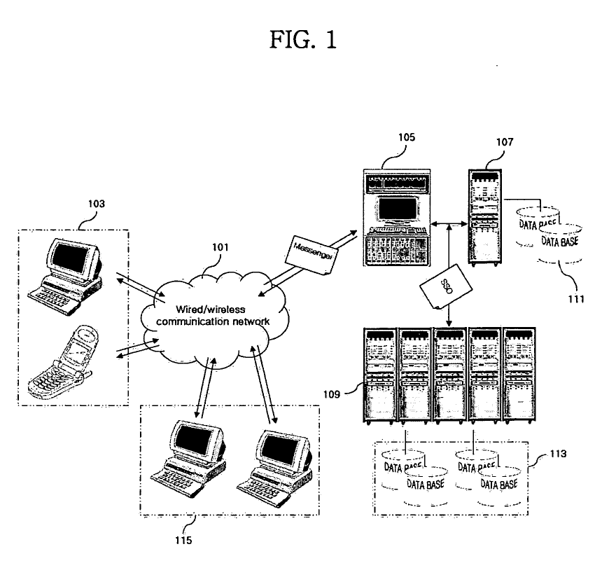

FIG. 1 is a diagram illustrating the construction of a network system according to the present invention.

Referring to FIG. 1, the network system according to the present invention includes a wired/wireless communication network 101, user terminals 103 connected to the wired/wireless communication network 101 for requesting and receiving information and materials, expert terminals 115 for transmitting pertinent information or materials from knowledge experts in corresponding fields in response to the request for information by a user, a web server 105 for transmitting the information and materials on-line and driving a messenger, a portal server 107 cooperatively operated with the web server 105 for performing user authentication and transmitting information corresponding to materials requested by the user, a user authentication database 111 connected to the portal server 107 for storing a user's basic information for user authentication therein, a service server 109 for providing professional knowledge information corresponding to the materials requested by the user, and a professional knowledge information database 113 connected to the service server 109 for storing materials information provided by the expert terminals 115 therein so as to utilize them as the professional knowledge information.

The portal server 107 provides a web page for searching knowledge information and registering/managing the knowledge information according to the present invention. The user can not only utilize the web page, but also use a knowledge search. Furthermore, in the present invention, the knowledge information can be searched, registered and managed through the service server 109 without using the portal server 107 that provides the web page, if necessary. In addition, the main functions of the service server 109 are performed in conjunction with the web page provided by the portal server 107.

The user terminal 103 may be a personal computer, a mobile phone, a PDA, and so forth, which allows for connection to the Internet and to a messenger for real time dialogue and file transmission. The web page is a predetermined portal site and is connected via a network such as WEB and WAP. Furthermore, the web server 105 has a Single Sign On (hereinafter referred to as “SSO”) security application solution therein, which can permit access to the service server 109 based on a user's log-on information that is inputted at the beginning.

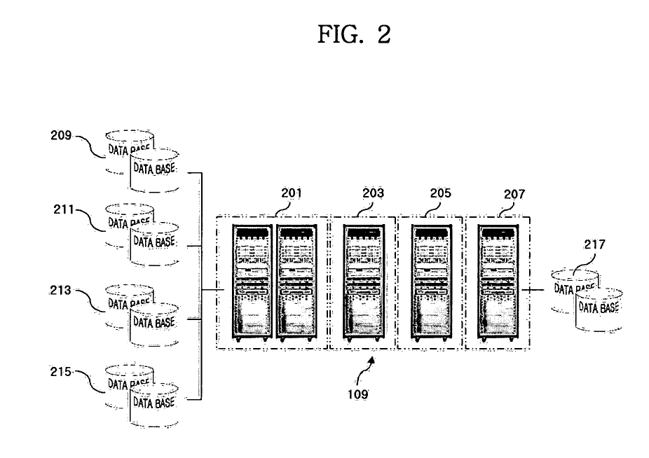

FIG. 2 is a diagram illustrating a detailed construction of the service server 109 shown in FIG. 1 according to the present invention.

Referring to FIG. 2, the service server 109 includes a search server 205 for searching the professional knowledge information database 113 for professional knowledge information corresponding to information requested by a user, a mail server 203 for transmitting the resulting information searched in the search server 205 or information provided by the portal server 107 to the user terminal 103, a contents server 207 for providing a plurality of services, for example shopping, CoP, entertainment and so on, and a contents database 217 for storing the plurality of the services therein. Meanwhile, the service server 109 further includes a knowledge server 201 for classifying knowledge corresponding to the user's inquiry and information on its corresponding response and operating/managing the professional knowledge information database 113. The professional knowledge information database 113 includes a knowledge database 209 for storing accumulated professional knowledge information containing knowledge information for which the process of creating knowledge is being performed such as inquiries/responses therein, a field database 211 for storing classification information classified by the field that classifies corresponding fields for respective knowledge, an expert database 213 for holding professional knowledge information on corresponding knowledge by the region and field, which is provided by the expert terminal 115, and a user database 215 for storing knowledge setting information classified by the individual therein, such as mileage information, inquiry/response history information, my knowledge information, favorite knowledge information, etc by the individual, as a user's personal information.

The operation of the knowledge information search system according to the present invention will now be described in detail with reference to the accompanying drawings.

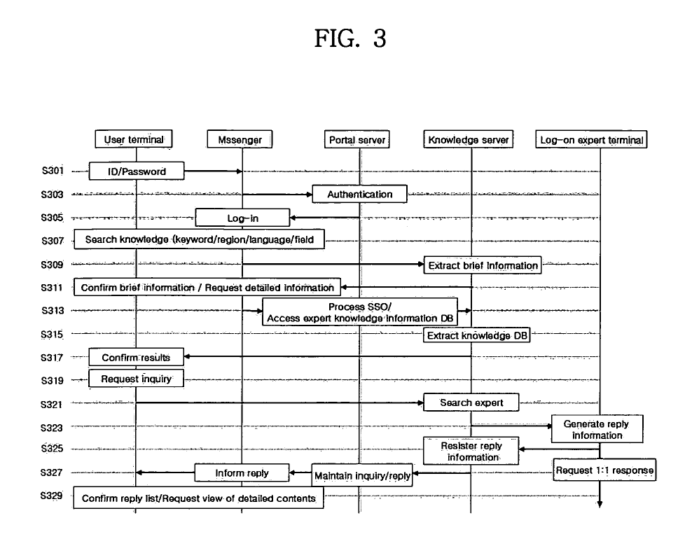

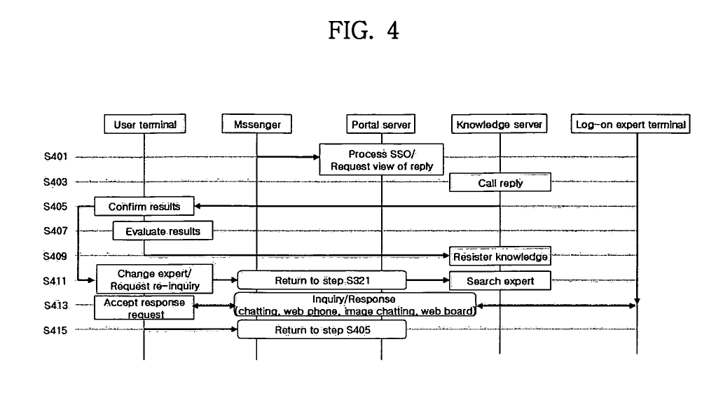

FIG. 3 and FIG. 4 are flowcharts shown to explain main operations in the network according to the present invention.

The user terminal 103 performs a network connection via the wired/wireless communication network 101 and then inputs an identifier (ID) and password of a user messenger (S301). The portal server 107 performs authentication based on the ID and password (S303). The portal server 107 sends the authentication result to the messenger, which then performs a log-on procedure based on the authentication result (S305). Thereby, a normal messenger service is accomplished.

At this time, the user inputs information classified by the keyword, region, language and field for performing the knowledge search through the user terminal 103 (S307). This is for selecting a corresponding region and selecting a language to use and a field to be searched. This causes the knowledge search to be classified by the country, language and field on an integrated network, so that the search can be facilitated. The information for the knowledge search, which is inputted as such, is sent to the service server 109 through the messenger, i.e., the web page provided by the portal server 107. The knowledge server 201 of the service server 109 extracts information corresponding to the request for the knowledge search from the knowledge database 209 or the contents database 217 of the contents server 207 (S309). In this case, the knowledge database 209 stores the basic information therein, which is common sense information that does not require an expert's reply. Accordingly, the knowledge database 209 or the contents database 217 stores live information and brief knowledge information therein, which is inputted/outputted to/from the Internet.

The brief information extracted by the knowledge server 201 may be provided to the user terminals 103 through the messenger, or through the portal server 107 (S311). If corresponding brief information is provided via the portal server 107, the portal server 107 notifies that reply information for the brief information has arrived using a corresponding messenger. The user confirms search list information corresponding to the brief information through a predetermined web page of the portal server 107 based on alarm information of a corresponding messenger. At this time, as a result of the confirmation of the brief information, if detailed information on the corresponding information is requested, the detailed information is requested by clicking the mouse and a request signal for the detailed information is sent to the portal server 107. The portal server 107 then provides the SSO process, i.e., a portal that will connect a detailed page based on the ID and password information inputted in step S301 (S313). This is for providing detailed information accumulated in the expert database 213. The knowledge server 201 enables the knowledge database 209 at the request of the portal server 107.

The knowledge server 201 extracts corresponding knowledge information from the knowledge database 209 based on selection information classified by the keyword, region, language and field for the knowledge search (S315). The extracted knowledge information is made listed and is then provided as list information through the web page of the portal server 107. Further, what reply information for the previously requested knowledge information has arrived is informed through the messenger to which the user is being currently connected.

The user terminal 103 enters step S317, wherein the user moves to the web page and then confirms a corresponding list and reply information for the knowledge information extracted from the knowledge database 209 (S317). As a result of the confirmation, the user may perform the evaluation for the corresponding knowledge information. If the evaluation result is satisfactory, the user may finish a corresponding knowledge search. On the contrary, if the evaluation result is not satisfactory, the user may request an inquiry to a corresponding expert (S319).

Predetermined information is added or modified based on the selection information classified by the keyword, region, language and field corresponding to the knowledge search, which are inputted at the beginning, as in step S321. The modified information is then resent to the knowledge server 201. Therefore, the knowledge server 201 can search a corresponding expert based on the added/modified keyword information, and the information classified by the region, language and field.

The search for the expert is to find the expert terminal 115, which is being currently connected. This is performed, by extracting experts corresponding to the keyword among the plurality of the experts who are already registered and then selecting experts classified by the region and language from the plurality of the experts so as to provide professional knowledge desired by the user.

Therefore, the knowledge server 201 can extract corresponding experts based on a predetermined data classification algorithm, and select an expert of the expert terminal 115 that is being currently connected to the Internet, from the extracted experts. The knowledge server 201 transmits the added/modified keyword information to a corresponding expert terminal 115 to request a reply (S323). At this time, it will be preferred that the inquiry information is sent to a corresponding expert terminal 115 through the messenger. Also the expert reply corresponding to the inquiry information may include a variety of materials, etc., including text information. The messenger may be used, or an additional pop-up window or a chatting window using chatting, a web phone, image chatting, a web board and the like may be used.

The expert terminal 115 can communicate with the experts one-to-one about the reply corresponding to the inquiry information through an additional communication means, as needed. The expert may request such a communication means to the user. On the contrary, if the expert wants to provide the reply information through a corresponding network system without using the additional communication means, the expert terminal 115 enters registers the reply information in the knowledge server 201 (S325). The knowledge server 201 classifies the registered information and stores corresponding information in the expert database 213. Furthermore, the knowledge server 201 transmits the reply information to the user terminal 103 (S327). In this case, the messenger informs the user terminal 103 of whether the corresponding reply information has arrived or not. Accordingly, the user confirms a corresponding reply list through the web page of the portal server 107 (S329).

The user terminal 103 confirms the reply list, requests the reception of the reply information for receiving the reply information. That is, the messenger sends a request signal corresponding to the reply information request to the portal server 107 by clicking the reply list (S401). Next, the portal server 107 executes the SSO process (S403) and accordingly performs connection with the knowledge server 201. Therefore, the knowledge server 201 extracts the reply information stored in the expert database 213 and then sends the extracted reply information to the user terminal 103 through the messenger. The messenger calls the user terminal 103. The user terminal 103 recognizes the call information through the messenger and then confirms detailed contents of the reply information (S405).

In step S407, the user terminal 103 performs the evaluation for the reply information as well as the confirmation of the reply information. If the evaluation result is satisfactory, the user terminal 103 finishes the process for the knowledge search (S407). In this case, evaluation information on the evaluation is provided to the knowledge server 201. That is, a completed shape of knowledge in which the user's inquiry information, the expert's reply information and the evaluation information are combined is constructed and registered (S409). Such knowledge information is classified by the field or keyword and is combined with its evaluation, thereby make it databased. The databased reply information, including corresponding evaluation information and inquiry information, is stored in the knowledge database 209.

On the contrary, if it is confirmed that the user is not satisfactory with the reply information in step S405 and requests a new reply for it, the user terminal 103 inquires the same expert about reply information again through the messenger or requests a change to a new expert. The knowledge server 201 recognizes this request and then returns to step S321 via step S411, in which the knowledge server 201 searches a new expert and then repeats the above process.

Meanwhile, the expert terminal 115 can maximize efficiency of not only the transmission of the reply information through the messenger but also information provision through the one-to-one connection to the user terminal 103. That is, as in step S413, the expert terminal 115 requests provision of a reply using the functions such as chatting, a web phone, image chatting, a web board, etc. to the user terminal 103. At this time, if the user terminal 103 accepts the request, the user confirms corresponding reply information. The user then returns to step S405 to repeat the same process. In this case, the knowledge server 201 accumulates corresponding knowledge information by automatically storing reply information provided through the pop-up window or chatting window functions such as chatting, a web phone, image chatting, a web board and the like as voice messages or text information. The chatting window is the means for automatically storing information exchanged between the user terminal 103 and the expert terminal 115, wherein audio or video information is stored through a predetermined compression process.

The information accumulated as such becomes a basis for a knowledge search requested by other user. The search server 205 generates search request information for the inquiry information based on the user's request information, and then sends the search request information to the knowledge server 201. The knowledge server 201 thus extracts brief information from the knowledge database 209 or the contents database 217 of the contents server 207 and then provides the expert's reply information in conjunction with the expert database 213 of the knowledge server 201 according to the search request information of the search server 205.

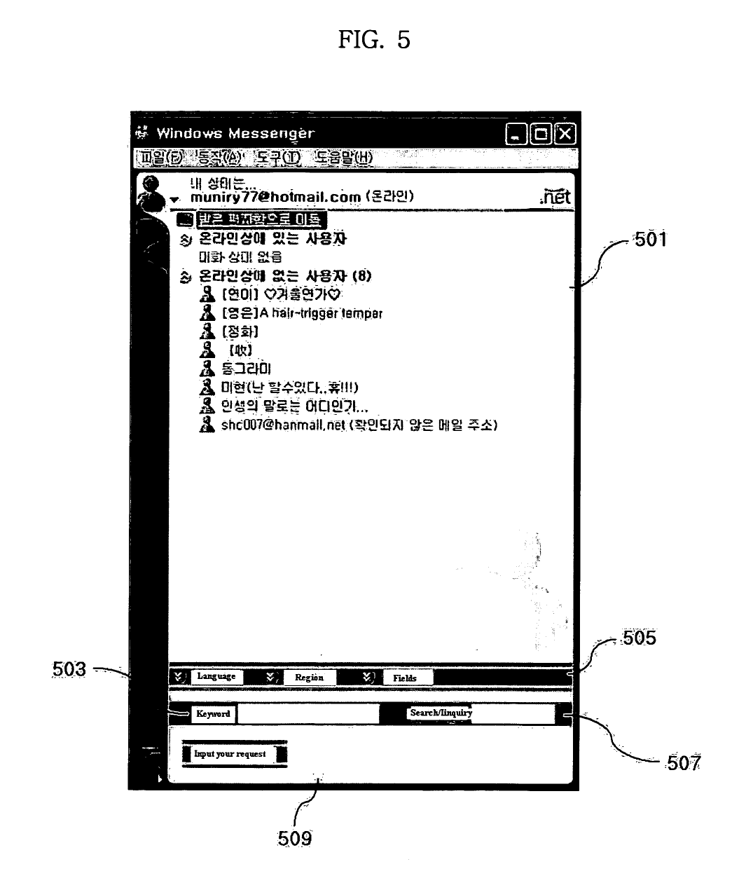

FIG. 5 shows a messenger having the knowledge information search function according to an embodiment of the present invention. Although it is shown that the knowledge search function is combined with the messenger, it can be cooperatively operated with other portal sites other than the messenger. As shown in FIG. 5, the messenger 501 allows for a real-time character dialogue among users. A knowledge search column is disposed at the bottom of the messenger 501 so that the user can receive information on new knowledge during the dialogue. In other words, the user can select a language and input knowledge classification for request information classified by the region and field through the knowledge classification column 505, so as to search desired knowledge during a character dialogue using the messenger. The user then requests an inquiry through keyword column 503 and an inquiry/search column 507.

If reply information for the requested inquiry is generated, this fact is notified through a corresponding messenger 501. The user then confirms corresponding reply information after confirming the notification. As described thereinbefore, when messenger (501) is connected in on-line, inputted user's ID and password information enable a messenger (501) to be connected with Knowledge server (201) via SSO system, thereby user terminal can confirm corresponding reply information. Further, if a consistent inquiry for reply information is needed, the user can input additional information or addition/modification information on the keyword for requesting pertinent knowledge through the question input column 509. Also the user can request detailed information on the reply information through the question input column 509. In this case, requested text information is character information that can be recognized by the knowledge server 201.

Meanwhile, the experts who are connected through the expert terminal 115 are engaged in all kinds of fields. They may include all sorts and conditions of people such as medical service, judicial affairs, administration, taxation affairs/the account, securities, insurance, finance, travel, real estate, fortune, cars, health, children, leisure, wedding, education and so on. The respective expert can be utilized upon the knowledge search and can make public corresponding fields or themselves, which may result in profits.

### INDUSTRIAL APPLICABILITY

As described above, according to a real-time knowledge information search system using wired/wireless networks and a method for registering/managing knowledge information using the same, a knowledge search is performed through a communication means among people. Therefore, the present invention has an effect that desired information at a desired time could be obtained in real time. In addition, there is an effect that a systematic knowledge management through a knowledge search and knowledge creation can be maximized since information classified by the region, language and field that is generated from experts is accumulated.

Furthermore, according to the present invention, it is possible to provide environment and circumstance that can create a profit model of on-line communication based on knowledge information that is accumulated in real time. It is also possible to provide a network structure that can make public corresponding experts and produce profits.

What is claimed is:

1. A real-time knowledge information search system using wired/wireless communication networks in a network system for providing an on-line portal service to a user terminal through the wired/wireless communication networks, comprising:
one or more user terminals connected to the wired/wireless communication networks, for generating inquiry information using an on-line communication means and receiving corresponding materials for the inquiry;
one or more expert terminals connected to the wired/wireless communication networks, for providing reply information of pertinent knowledge classified by corresponding fields according to a user's information request;
a service server for transmitting the inquiry information of the user to the expert terminals that are being currently connected, transmitting the expert's reply information to the user terminal through the on-line communication means, and classifying data for the reply information, in response to the user's information request; and
a professional knowledge information database connected to the service server, for classifying/storing the reply information provided from the expert terminals therein, so that the reply information is used as professional knowledge information corresponding to a user's professional knowledge request.

2. The real-time knowledge information search system as claimed in claim 1, wherein the user terminals are any one of a personal computer, a mobile phone and a PDA, which can connect to the Internet.

3. The real-time knowledge information search system as claimed in claim 1, wherein the one or more expert terminals are expert's terminals that are being currently connected, which are classified by the field, language and region.

4. The real-time knowledge information search system as claimed in claim 1, wherein the on-line communication means is a messenger.

5. The real-time knowledge information search system as claimed in claim 4, wherein the on-line communication means is an Internet portal site.

6. The real-time knowledge information search system as claimed in claim 1, wherein the user terminal performs an on-line connection of the on-line communication means via predetermined authentication procedure, and the service server has a SSO security application solution therein, which permits access of the user terminals based on a user's log-on information that is initially inputted.

7. The real-time knowledge information search system as claimed in claim 1, wherein the service server comprises:
a search server for classifying professional knowledge information corresponding to the user's request information and searching the professional knowledge information database for the professional knowledge information;
a mail server for transmitting the result information searched in the search server or information provided by the portal site to the user terminal;
a contents server for providing a plurality of additional service information; and
a knowledge server for classifying knowledge for a user's inquiry, classifying information on response, and operating and managing the professional knowledge information database.

8. The real-time knowledge information search system as claimed in claim 1, wherein the user terminals provide the degree of satisfaction for the reply information in numerical information, the professional knowledge information database matches the reply information and the numerical information and then stores the matched information therein, and the service server provides corresponding reply information and its numerical information when the user requests professional knowledge.

9. A method for searching knowledge information for an on-line portal service in real-time using wired/wireless communication networks, comprising the steps of:
a) performing an authentication procedure for accessing an on-line communication means to a user terminal;
b) generating inquiry information for a knowledge search through the on-line communication means;
c) analyzing the inquiry information, and extracting previously stored basic information from a database depending on the analysis result;
d) providing list information on the basic information through a web page of the portal service;
e) confirming reply information provided from the list information through the user terminal, and if detailed information on the reply information is not requested, finishing a corresponding process and if detailed information on the reply information is requested, searching a plurality of experts who are previously registered based on the analysis result for the inquiry information;
f) extracting an expert who is being currently connected among the plurality of the experts, and transmitting the inquiry information to an expert terminal of the selected expert through the on-line communication means;
g) requesting an on-line access for transmitting the reply information corresponding to the inquiry information, which is provided from the expert terminal, to the user terminal;
h) if the user terminal does not accept the on-line access request, finishing a corresponding process, and if the user terminal accepts the on-line access request, allowing the user terminal and the expert terminal to be connected one-to-one with each other through real-time on-line information transmit means;
i) storing reply information provided to the user terminal in the database during the one-to-one connection between the user terminal and the expert terminal; and
j) in response to the reply information, finishing a corresponding process or returning to step f) by providing added/modified information for the inquiry information.

10. The method for searching knowledge information as claimed in claim 9, wherein the on-line communication means is a messenger.

11. The method for searching knowledge information as claimed in claim 9, wherein the access to the database through the on-line communication means is an access method based on personal information provided in the authentication procedure and a SSO security application solution.

12. The method for searching knowledge information as claimed in claim 9, wherein the inquiry information is keyword containing selection information classified by the language, region and field.

13. The method for searching knowledge information as claimed in claim 9, wherein the user terminal is any one of a personal computer, a mobile phone and a PDA, which can connect to the Internet.

14. The method for searching knowledge information as claimed in claim 9, wherein the user terminal generates evaluation information on the reply information, and the database matches the inquiry information and the reply information and then stores the matched information therein, and provides the reply information based on the evaluation information when providing the basic information in step c).

15. A method for storing/managing knowledge information for an on-line portal service, comprising the steps of:
a) performing an authentication procedure for accessing an on-line communication means to a user terminal;
b) generating inquiry information through the on-line communication means;
c) searching a plurality of experts who are previously registered based on an analysis result into the inquiry information;
d) extracting an expert who is being currently connected to the Internet among the plurality of the experts, and sending the inquiry information to an expert terminal of the extracted expert through the on-line communication means;
e) requesting an on-line access for transmitting reply information corresponding to the inquiry information that is provided from the expert terminal, to the user terminal;
f) if there is no acceptance for the on-line access request from the user terminal, finishing a corresponding process, and if there is acceptance for the on-line access request from the user terminal, allowing the user terminal and the expert terminal to be connected one-to-one with each other through real-time on-line information transmit means;
g) storing the inquiry information and the reply information, being the results of the communication exchange among the user terminal and the expert terminal, in a database; and
h) in response to the reply information, finishing a corresponding process, or returning to step e) by providing added/modified information for the inquiry information through the user terminal.

16. The method for storing/managing knowledge information as claimed in claim 15, wherein the on-line communication means is a messenger, and the real-time on-line information transmit means is a chatting window, which is any one of chatting, a web phone, image chatting and a web board.

17. The method for storing/managing knowledge information as claimed in claim 15, wherein the user terminal generates evaluation information on the reply information, and
the database matches the inquiry information and the reply information, and the evaluation information, and then stores the matched information therein.

18. The method for storing/managing knowledge information as claimed in claim 15, wherein the access to the database through the on-line communication means is an access method based on personal information provided in the authentication procedure and a SSO security application solution.

19. The method for storing/managing knowledge information as claimed in claim 15, wherein the inquiry information is keyword containing selection information classified by the language, region and field.

20. The method for storing/managing knowledge information as claimed in claim 15, wherein the user terminal is any one of a personal computer, a mobile phone and a PDA, which can connect to the Internet.

21. The method for storing/managing knowledge information as claimed in claim 15, wherein the reply information is any one of text data information, video information, and recording information.
